(19) United States
(12) Patent Application Publication
(10) Pub. No.: US 2016/0297000 A1
(43) Pub. Date: Oct. 13, 2016

(54) DIE-CASTING SYSTEM WITH BONDED CERAMIC SHOT TIP

(71) Applicant: UNITED TECHNOLOGIES CORPORATION, Hartford, CT (US)

(72) Inventors: LIM YUAN KWANG, Singapore (SG); Tan Yong Sheng Andrew, Singapore (SG); MUHAMMAD AZZLI BIN MAHMOOD, Singapore (SG); CHEE YAO HUI, Singapore (SG)

(21) Appl. No.: 14/682,441

(22) Filed: Apr. 9, 2015

(51) Int. Cl. B22D 17/20; B32B 37/12

(52) U.S. Cl. CPC B22D 17/203; B32B 37/12; B32B 2037/1246

(57) ABSTRACT

A shot sleeve plunger for a die-casting system includes a ceramic tip bonded to the piston rod shank via a bond layer. A die-casting system can include a shot sleeve plunger slidably received within a shot sleeve, the shot sleeve plunger having a ceramic tip bonded to a piston rod shank. A method of manufacturing a shot sleeve plunger can include bonding a ceramic tip to a piston rod shank.

### BACKGROUND

The present disclosure relates to die-casting and, more particularly, to a plunger tip with a ceramic bonded shot tip.

Die-casting is often utilized to manufacture near net-shaped components, typically low melting point alloys that can include parts with relatively complex geometries. For casting of high temperature superalloys, investment casting is a typical route. It is a novel process to die-cast superalloys. A component is investment cast by injecting molten metal into a ceramic shell having a cavity in the shape of the component to be cast via an injection unit with a shot sleeve plunger.

In a die-cast tooling system, the plunger tip and the shot sleeve commonly encounter tool life limits. Typically, the plunger is slightly undersized in OD (outer diameter) compared to the ID (inner diameter) of the shot sleeve, to provide a sliding fit. However, when molten metal is poured into the opening of the shot sleeve, the plunger expands which may result in interference with the ID of the shot sleeve. To control the expansion, cooling water is circulated within the plunger and the plunger tip, which, although effective, may still havedeformation, and thus interference between the plunger and shot sleeve.

Over time, the surface of both plunger and shot sleeve deteriorates until the former sticks inside the shot sleeve despite the plunger being water chilled. Once the plunger sticks into the sleeve, a high tonnage press may be utilized to remove and replace the metallic shot tip from the shot sleeve. This may result in damage to the more expensive shot sleeve.

Presently, a disposable ceramic tip is slotted onto a metallic shank of the shot tip to allow retraction of only the smaller diameter metal shank when the plunger rod retracts. Although, this can completely alleviate wear on the shot sleeve, the ceramic tip must be replaced for every single shot which, although effective, may be relatively uneconomical, expensive and time consuming

### SUMMARY

A shot sleeve plunger according to one disclosed non-limiting embodiment of the present disclosure can include a piston rod shank and a ceramic tip bonded to the piston rod shank via a bond layer.

A further embodiment of the present disclosure may include, wherein the bond layer includes a ceramic-to-metal adhesive.

A further embodiment of any of the foregoing embodiments of the present disclosure may include, wherein the bond layer includes a ceramic-to-metal putty.

A further embodiment of any of the foregoing embodiments of the present disclosure may include, wherein the bond layer includes an indium bonding.

A further embodiment of any of the foregoing embodiments of the present disclosure may include, wherein the ceramic tip defines a diameter greater than a diameter of the piston rod shank.

A further embodiment of any of the foregoing embodiments of the present disclosure may include, wherein the piston rod shank is removably mountable to a plunger section of the shot sleeve plunger.

A further embodiment of any of the foregoing embodiments of the present disclosure may include, wherein the piston rod shank is threaded onto a plunger section of the shot sleeve plunger.

A die-casting system according to another disclosed non-limiting embodiment of the present disclosure can include a shot sleeve plunger slidably received within a shot sleeve, the shot sleeve plunger having a ceramic tip bonded to a piston rod shank.

A further embodiment of any of the foregoing embodiments of the present disclosure may include, wherein the ceramic tip defines a diameter greater than a diameter of the piston rod shank.

A further embodiment of any of the foregoing embodiments of the present disclosure may include, wherein an outer diameter of the ceramic tip the only surface to contact an inner diameter of the short sleeve.

A further embodiment of any of the foregoing embodiments of the present disclosure may include, wherein the piston rod shank is removably mountable to a plunger section of the shot sleeve plunger.

A further embodiment of any of the foregoing embodiments of the present disclosure may include, wherein the piston rod shank is threaded onto a plunger section of the shot sleeve plunger.

A method of manufacturing a shot sleeve plunger according to another disclosed non-limiting embodiment of the present disclosure can include bonding a ceramic tip to a piston rod shank.

A further embodiment of any of the foregoing embodiments of the present disclosure may include, wherein the bonding includes a ceramic-to-metal adhesive.

A further embodiment of any of the foregoing embodiments of the present disclosure may include, wherein the bonding includes a ceramic-to-metal putty.

A further embodiment of any of the foregoing embodiments of the present disclosure may include, wherein the bonding includes an indium bonding.

A further embodiment of any of the foregoing embodiments of the present disclosure may include, wherein the ceramic tip defines a diameter greater than a diameter of the piston rod shank.

A further embodiment of any of the foregoing embodiments of the present disclosure may include, wherein the ceramic tip defines an interface surface with the shot sleeve.

A further embodiment of any of the foregoing embodiments of the present disclosure may include, wherein the piston rod shank is threaded onto a plunger section of the shot sleeve plunge.

A further embodiment of any of the foregoing embodiments of the present disclosure may include, wherein the plunger section of the shot sleeve plunge is mounted in a mechanism to provide reciprocal motion of the shot sleeve plunger within a shot sleeve.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a schematic cross-sectional view of a die casting mold;

FIG. 2 is an exploded view of a shot sleeve plunger; and

FIG. 3 is a schematic cross-sectional view of the shot sleeve plunger within a shot sleeve.

### DETAILED DESCRIPTION

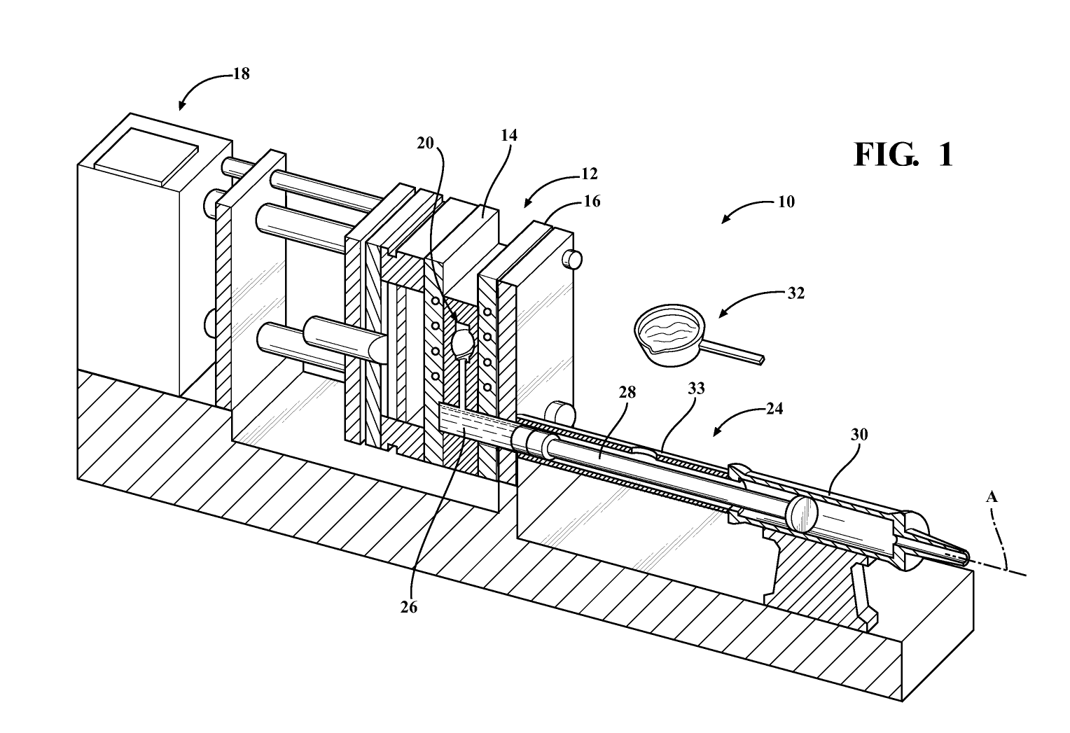

FIG. 1 schematically illustrates a die-casting system 10. The die casting system 10 generally includes a reusable die 12 having a plurality of die elements 14, 16 that function to cast a component 15. Although two die elements 14, 16 are depicted, it should be appreciated that the die 12 could include more die elements, as well as other parts and configurations. The example die casting system 10 is illustrative only and could include more or less sections, parts and/or components including, but not limited to, horizontal, inclined, and vertical die casting systems.

The die 12 is assembled and retained at a desired position via a clamp mechanism 18. Such as a hydraulic, pneumatic, electromechanical and/or other configurations. The mechanism 18 also separates the die elements 14, 16 subsequent to casting.

The die elements 14, 16 define internal surfaces that cooperate to define a die cavity 20. A shot sleeve 24 is in fluid communication with the die cavity 20 via one or more ports 26 located in the die element 16, the die element 14, or both. A shot sleeve plunger 28 is received within the shot sleeve 24 and is moveable between a retracted and injection position (arrow A) within the shot sleeve 24 by an actuator 30 such as a hydraulic, pneumatic, electromechanical, or any combination thereof.

The shot sleeve 24 is positioned to receive a molten metal from a melting unit 32, such as a crucible, for example. The melting unit 32 operates to melt an ingot of metallic material to prepare a molten metal for delivery to the shot sleeve 24, including but not limited to, vacuum induction melting, electron beam melting and induction melting. The molten metal is melted by the melting unit 32 at a location that is separate from the shot sleeve 24 and the die 12.

Example molten metals for the die cast component include, but are not limited to, nickel based super alloys, titanium alloys, high temperature aluminum alloys, copper based alloys, iron alloys, molybdenum, tungsten, niobium, or other refractory metals. This disclosure is not limited to the disclosed alloys, and it should be appreciated that any high melting temperature material may be utilized to die cast the component. As used herein, the term “high melting temperature material” is intended to include materials having a melting temperature of about 1500° F. (815° C.) and higher.

The molten metal is transferred from the melting unit 32 to the shot sleeve 24 such as via pouring the molten metal into a pour hole 33 of the shot sleeve 24. A sufficient amount of molten metal is poured into the shot sleeve 24 to fill the die cavity 20. The shot sleeve plunger 28 is actuated to inject the molten metal under pressure from the shot sleeve 24 into the die cavity 20 to cast the component. Although the casting of a single component is depicted, the die casting system 10 could be configured to cast multiple components in a single shot.

Although not necessary, at least a portion of the die casting system 10 may be positioned within a vacuum chamber. The vacuum chamber provides a non-reactive environment for the die casting system 10 that reduces reaction, contamination, or other conditions that could detrimentally affect the quality of the cast component, such as excess porosity of the die cast component that can occur as a result of ingressed air during molten metal solidification.

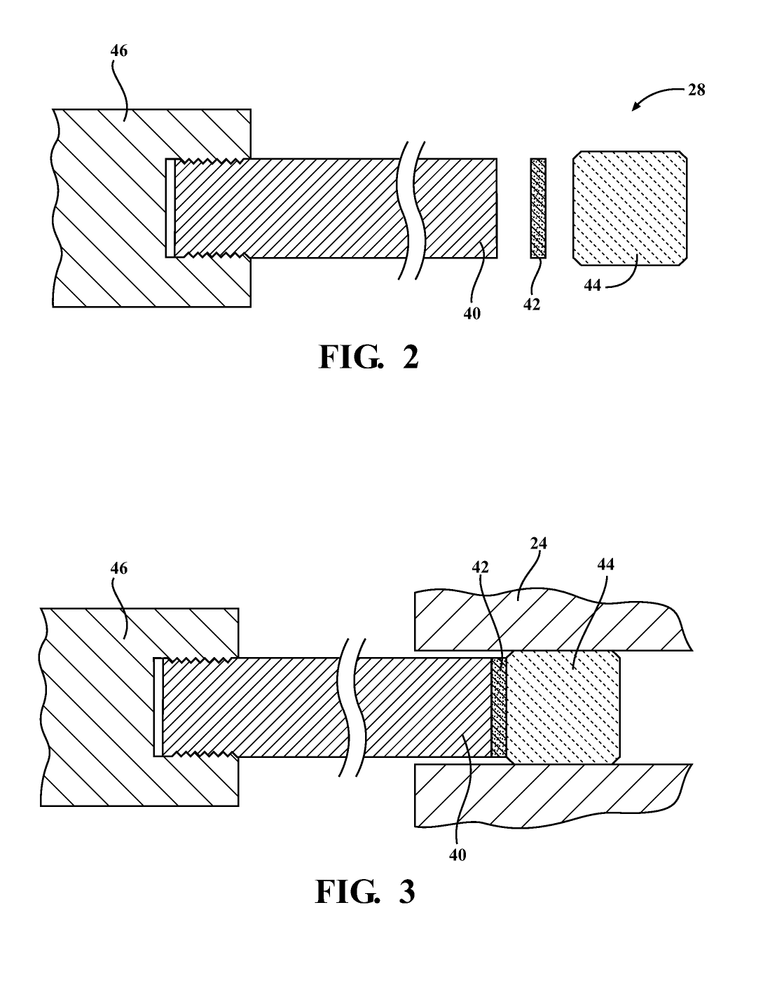

With reference to FIG. 2, the shot sleeve plunger 28 according to one disclosed non-limiting embodiment includes a piston rod shank 40, a bond layer 42, and a ceramic tip 44. The piston rod shank 40 is typically threaded into a plunger section 46 of the shot sleeve plunger 28 and may be manufactured of a metallic material such as tool steel. The piston rod shank 40 need not include water cooling since the ceramic tip 44 is minimally affected by the hot molten metal. The bond layer 42 may be formed by a suitable ceramic-to-metal adhesives, putty, thin indium bonding, or any other material to affix the ceramic tip 44 to the piston rod shank 40. In one example, an indium bond layer can have tensile bond strength of about 700 PSI which allows a bonded assembly to be detached without scouring the length of the tube as the piston rod retracts in an event of tip/tube interference condition.

With reference to FIG. 3 the ceramic tip 44 may be of a larger diameter than that of the piston rod shank 40 such that the ceramic tip 44 interfaces with the molten metal, as well as being the contact surface with the ID of the shot sleeve 24. That is, the ceramic tip 44 defines the interface surface with the shot sleeve 24.

This configuration beneficially utilizes ceramics for the shot tip that are generally chemically inert and resistant to high melting point materials such that water cooling may be avoided. This simplifies the entire die-cast process and eliminates risk of any molten metal-to-cooling water contact. The ceramic tip 44 also obviates the need for lubricants unlike metallic shot tips where repetitive circumferential application of lubricants is required. The ceramic tip 44 is also not a one-off disposable item as it retracts with the plunger rod after the die-cast stroke has been accomplished.

Should severe interference occurs between ceramic tip and shot sleeve due to, for example, warping of the shot sleeve, tensile forces generated on the surface of the ceramic tip would break the ceramic tip off. This is essentially a fail safe that protects the larger and more expensive shot sleeve whilst sacrificing the ceramic tip. The system would therefore not jam inside the tube, whilst the shot sleeve, shank and rod can still be re-used. Replacement of the ceramic tip 44 then only requires debonding the ceramic tip and re-fixing a new ceramic tip onto the metallic shank.

The use of the terms “a,” “an,” “the,” and similar references in the context of description (especially in the context of the following claims) are to be construed to cover both the singular and the plural, unless otherwise indicated herein or specifically contradicted by context. The modifier “about” used in connection with a quantity is inclusive of the stated value and has the meaning dictated by the context (e.g., it includes the degree of error associated with measurement of the particular quantity). All ranges disclosed herein are inclusive of the endpoints, and the endpoints are independently combinable with each other. It should be appreciated that relative positional terms such as “forward,” “aft,” “upper,” “lower,” “above,” “below,” and the like are with reference to the normal operational attitude of the vehicle and should not be considered otherwise limiting.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

It should be appreciated that like reference numerals identify corresponding or similar elements throughout the several drawings. It should also be appreciated that although a particular component arrangement is disclosed in the illustrated embodiment, other arrangements will benefit herefrom.

Although particular step sequences are shown, described, and claimed, it should be understood that steps may be performed in any order, separated or combined unless otherwise indicated and will still benefit from the present disclosure.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be appreciated that within the scope of the appended claims, the disclosure may be practiced other than as specifically described. For that reason the appended claims should be studied to determine true scope and content.

1. A shot sleeve plunger, comprising:
a piston rod shank; and
a ceramic tip detachably bonded to the piston rod shank via a bond layer, the ceramic tip defines a diameter greater than a diameter of the piston rod shank

2. The shot sleeve plunger as recited in claim 1, wherein the bond layer includes a ceramic-to-metal adhesive to from a bonded assembly that is detachable without scouring the length of a shot sleeve that receives the ceramic tip as the piston rod shank retracts in an event of a tip/shot sleeve interference condition during operation.

3. The shot sleeve plunger as recited in claim 1, wherein the bond layer includes a ceramic-to-metal putty to from a bonded assembly that is detachable without scouring the length of a shot sleeve that receives the ceramic tip as the piston rod shank retracts in an event of a tip/shot sleeve interference condition during operation.

4. The shot sleeve plunger as recited in claim 1, wherein the bond layer includes an indium bonding to from a bonded assembly that is detachable without scouring the length of a shot sleeve that receives the ceramic tip as the piston rod shank retracts in an event of a tip/shot sleeve interference condition during operation.

5. (canceled)

6. (canceled)

7. The shot sleeve plunger as recited in claim 1, wherein the piston rod shank is threaded onto a plunger section of the shot sleeve plunger.

8. A die-casting system, comprising:
a shot sleeve; and
a shot sleeve plunger slidably received within the shot sleeve, the shot sleeve plunger having a ceramic tip detachably bonded to a piston rod shank, the ceramic tip defines a diameter greater than a diameter of the piston rod shank to interface with the shot sleeve.

9. (canceled)

10. The system as recited in claim 8, wherein an outer diameter of the ceramic tip is the only surface to contact an inner diameter of the shot sleeve.

11. The system as recited in claim 8, wherein the piston rod shank is removably mountable to a plunger section of the shot sleeve plunger.

12. The system as recited in claim 8, wherein the piston rod shank is threaded onto a plunger section of the shot sleeve plunger.

13. A method of manufacturing a shot sleeve plunger, comprising:
detachably bonding a ceramic tip to a piston rod shank to form a bonded assembly, the ceramic tip defines a diameter greater than a diameter of the piston rod shank, the bonded assembly detachable without scouring the length of a shot sleeve as the piston rod shank retracts in an event of tip/shot sleeve interference condition during operation.

14. The method as recited in claim 13, wherein the bonding includes a ceramic-to-metal adhesive bonding.

15. The method as recited in claim 13, wherein the bonding includes a ceramic-to-metal putty bonding.

16. The method as recited in claim 13, wherein the bonding includes an indium bonding.

17. (canceled)

18. The method as recited in claim 13, wherein the ceramic tip defines an interface surface with the shot sleeve.

19. The method as recited in claim 13, wherein the piston rod shank is threaded onto a plunger section of the shot sleeve plunger.

20. The method as recited in claim 19, wherein the plunger section of the shot sleeve plunger is reciprocally movable within a shot sleeve.

21. The shot sleeve plunger as recited in claim 4, wherein the bonded assembly has a tensile bond strength of about 700 PSI.

22. The shot sleeve plunger as recited in claim 1, wherein the bond layer is generally planar.

23. The shot sleeve plunger as recited in claim 1, wherein the bond layer interfaces with a face to face engagement surface.

24. The shot sleeve plunger as recited in claim 1, wherein the bond layer interfaces with a flat surface on the ceramic tip and a flat surface on the piston rod shank.
